(19) United States
(12) Patent Application Publication
(10) Pub. No.: US 2011/0288804 A1
(43) Pub. Date: Nov. 24, 2011

(54) Sighting Apparatus for Remote-Control Shooting System and Sight Alignment Method Using the Same

(75) Inventors: Dong Hee Lee, Gyeonggi-do (KR); In Jung, Gyeonggi-do (KR); Gyu Jung Choi, Incheon (KR)

(73) Assignee: In Jung, Gyeonggi-do (KR)

(21) Appl. No.: 13/110,190

(22) Filed: May 18, 2011

(30) Foreign Application Priority Data
May 19, 2010 (KR) 1020100046968

(51) Int. Cl. F41G 1/46; F41G 3/00; G06F 19/00; F41G 1/54; H04N 7/18; F41G 1/00; F41G 1/38

(52) U.S. Cl. 702/87; 89/41.19; 348/139; 348/E07.085

(57) ABSTRACT

Disclosed are a sighting apparatus for a remote-control shooting system and a sighting alignment method using the same. The sighting apparatus for a remote-control shooting system including a firearm installed in a firearm platform rotatable in up, down, left and right directions, and an observation camera installed to be position-adjustable in at the firearm platform, the sighting apparatus includes: a sighting unit which is fastened to the firearm with a zeroing unit precisely up, down, left and right adjustable therebetween, and takes a first image as zeroed; and a controller which controls the firearm platform so that an sighting indicator (e.g., a line) of the first image taken by the sighting unit can be aligned with a target, and aims at the target.

### CROSS-REFERENCE TO RELATED APPLICATION

This application claims priority to and the benefit of Korean Patent Application No. 10-2010-0046968 filed in the Korean Intellectual Property Office on May 19, 2010, the entire contents of which are incorporated herein by reference.

### BACKGROUND OF THE INVENTION

(a) Field of the Invention

The present invention relates to a sighting apparatus for a remote-control shooting system and a sighting alignment method using the same, and more particularly, to a sighting apparatus for a remote-control shooting system, which keeps zeroed even when a firearm is detached from and attached to a firearm platform, and a sighting alignment method using the same.

(b) Description of the Related Art

In general, a remote-control shooting control apparatus includes a remote shooting control device and a monitor for controlling shooting in an installed carrier and an inner or remote area of a place, a control device (e.g., a keyboard, a ball track, a joystick, a touch screen, etc.), and operates a head mount display (HMD). Further, external equipment that includes a laser range finder (LRF) for measuring a target distance, a day and night camera/thermal imaging camera for sighting and measuring, and a sensor (e.g., a global positioning system (GPS), a digital magnetic compass (DMC), a tilt sensor, etc.) is provided in a high precision pan/tilt mount for moving a support weapon (i.e., a firearm) up, down, left and right, and mounted to a left/right side or a bottom of the support weapon (i.e., the firearm).

However, a course axis of the support weapon (i.e., the firearm) and an optical axis of the electro optical shooting control apparatus are different with respect to a target. Further, a mechanical method and an electronic method are used for the control in accordance with distance from the target.

FIG. 1 shows a general sighting method of a conventional remote-control shooting apparatus. However, because of installation condition, load with bullets, replacement of a gun barrel, defect in a launcher, etc., the installed weapon (the firearm) 1 is changed in the course axis between the target and the firearm (sight) when the firearm is detached/attached or controlled. To decrease this change, a large, heavy and strong mount has been use. Nevertheless, there is a need of zeroing the sight of the camera again (for a reference point) after controlling the firearm. Thus, there is a problem that long time is taken to zero in the firearm at distances (for the reference point) and practice shooting for the realignment.

Also, in the case of equipment that is installed in a hiding area or the like environment where zeroing in a firearm is impossible, there is a problem that shooting precision is significantly lowered since it is impossible to zero in the firearm so as to prepare for an actual battle.

### SUMMARY OF THE INVENTION

Accordingly, the present invention is conceived to solve the forgoing problems, and an aspect of the present invention is to provide a sighting apparatus for a remote-control shooting system, which keeps zeroed even when a firearm is detached from and attached to a firearm platform for load with bullets, replacement of a gun barrel, defect in a launcher, or control.

Another aspect of the present invention is to provide a sighting apparatus for a remote-control shooting system, in which a sighting unit for aiming at a target is assembled in a firearm as it is zeroed, so that there will be no more concern over change in a course axis even when a firearm is detached from and attached to a firearm platform, and thus the firearm platform can become lightweight.

Still another aspect of the present invention is to provide a sighting alignment method using a sighting apparatus for a remote-control shooting system, which can quickly deal with an urgent situation since sight alignment is possible without conventional separate shooting for the zeroing even through a sighting indicator (e.g., a line) between a sighting unit and a camera is misaligned.

An exemplary embodiment of the present invention provides an sighting apparatus for a remote-control shooting system including a firearm installed in a firearm platform rotatable in up, down, left and right directions, and an observation camera installed to be position-adjustable in at the firearm platform, the sighting apparatus including: a sighting unit which is fastened to the firearm with a zeroing unit precisely up, down, left and right adjustable therebetween, and takes a first image as zeroed; and a controller which controls the firearm platform so that an sighting indicator (e.g., a line) of the first image taken by the sighting unit can be aligned with a target, and aims at the target.

The sighting apparatus may further include an image processor which compares a first image taken by the sighting unit with a second image taken by an observation camera, and calculates a compensating value on the basis of a position of a target shown in the sighting indicator (e.g., the line) of the first image and a position of a target shown in the second image, wherein the controller adjusts a position of the observation camera on the basis of the compensation value of the image processor so that the target shown in the second image can be positioned at the sighting indicator (e.g., the line), and thus adjusts optical axes of the sighting unit and the observation camera to face toward one target.

The sighting apparatus may further include a distance measurer which is installed in parallel with the observation camera and measures distance from a target.

The controller may adjust a position of a gun barrel so that a trajectory curve can intersect with a target in accordance with distance from the target based on the distance measured by the distance measurer.

The sighting unit may include one among a dot sight, a dot sight coupling with an afocal optical system, and a scope, and a sighting cameral installed so that the sighting indicator (e.g., the line) of one among the dot sight, the dot sight coupling with the afocal optical system, and the scope can be aligned with an optical axis.

The sighting unit may be mounted to the firearm through a distance-based trajectory compensator.

The sighting unit may include a sighting camera.

Another exemplary embodiment of the present invention provides a sighting alignment method using the sighting apparatus for the remote-control shooting system according to claim 1, the sighting alignment method including: adjusting the position of the firearm so that the sighting indicator (e.g., the line) of the sighting unit is aligned with a target (S11); taking a first image from the sighting unit fastened to the firearm as zeroed (S12); taking a second image from the observation camera (S13); determining whether target positions of the first image and the second image are the same (S14); calculating a position compensating value for the first image and the second image by analyzing the first image and the second image provided to the image processor if the target positions of the first image and the second image are different (S15); and moving the observation camera on the basis of the position compensating value so that the first image and the second image are matched with each other (S16).

The calculating the position compensating value (S15) may include selecting at least one reference image from the first image of the sighting camera (S15a), tracing an object image matched with a certain image of the first image from the second image of the observation camera (S15b), and calculating the position compensating value by comparing a position value corresponding to the reference image with a position value of the object image (S15c).

The calculating the position compensating value may include selecting an object point corresponding to the sighting indicator (e.g., the line) of the first image of the sighting camera from the second image, and calculating the position compensating value by comparing the object point with the position value of the sighting indicator (e.g., the line) of the second image.

After the moving the observation camera (S16), the determining whether the first image and the second image are matched with each other (S14) returns and then the calculating the position compensating value (S15) and the moving the observation camera (S16) are repeatedly performed until the first image and the second image are matched with each other.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 shows a general sighting method of a conventional remote-control shooting apparatus;

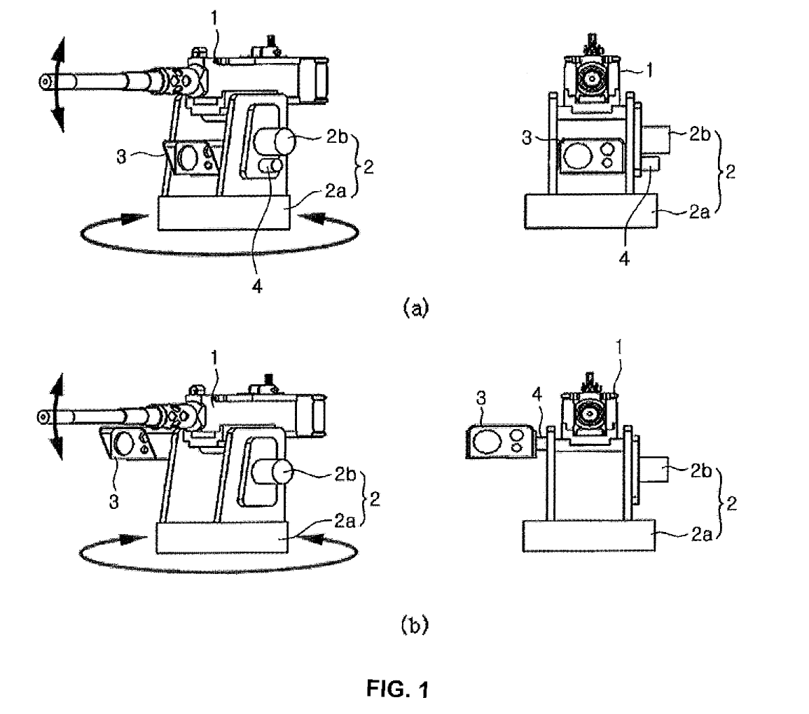

FIG. 2 is a block diagram showing relationship among main elements constituting a sighting apparatus for a remote-control shooting system according to a first exemplary embodiment of the present invention;

FIG. 3 is a plan view of the sighting apparatus for the remote-control shooting system according to the first exemplary embodiment of the present invention;

FIG. 4 is a block diagram showing relationship among main elements constituting a sighting apparatus for a remote-control shooting system according to a second exemplary embodiment of the present invention;

FIG. 5 is a plan view of the sighting apparatus for the remote-control shooting system according to the second exemplary embodiment of the present invention;

FIG. 6 shows various exemplary embodiments of a sighting unit according to the present invention;

FIG. 7 shows an image comparing process of a sighting alignment method using a sighting apparatus for a remote-control shooting system according to an exemplary embodiment of the present invention;

FIG. 8 is a flowchart of the sighting alignment method using the sighting apparatus for the remote-control shooting system according to an exemplary embodiment of the present invention;

FIG. 9 shows an image comparing process of a sighting alignment method using a sighting apparatus for a remote-control shooting system according to another exemplary embodiment of the present invention; and

FIG. 10 is a flowchart of the sighting alignment method using the sighting apparatus for the remote-control shooting system according to another exemplary embodiment of the present invention.

### DETAILED DESCRIPTION OF THE EMBODIMENTS

Prior to description, elements will be representatively explained in a first embodiment and only different configurations will be described in another embodiment, in which like reference numerals refer to like elements throughout the embodiments.

Hereinafter, a sighting apparatus for a remote-control shooting system according to a first exemplary embodiment of the present invention will be described with reference to the accompanying drawings.

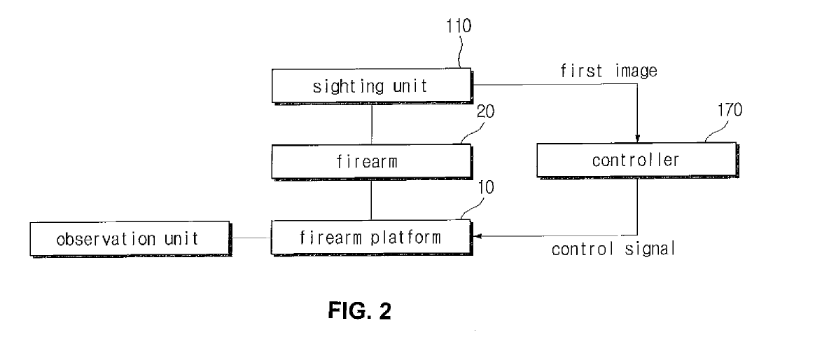

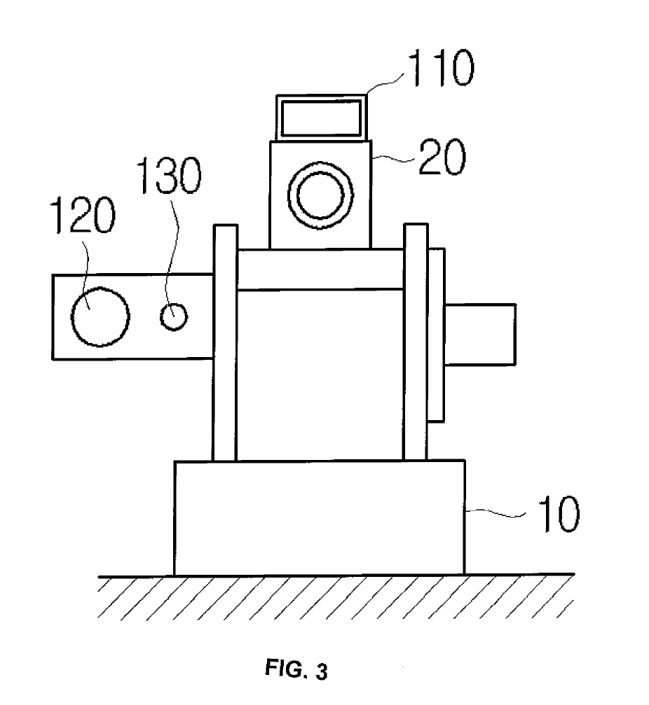

Among the accompanying drawings, FIG. 2 is a block diagram showing relationship among main elements constituting a sighting apparatus for a remote-control shooting system according to a first exemplary embodiment of the present invention, and FIG. 3 is a plan view of the sighting apparatus for the remote-control shooting system according to the first exemplary embodiment of the present invention.

As shown therein, the sighting apparatus for the remote-control shooting system according to the first exemplary embodiment of the present invention includes a sighting unit 110 which is fastened to a firearm 20 as it is zeroed by a zeroing unit 113 and takes a first image in the state that the firearm 20 is detachably installed in a firearm platform 10 having at least two driving shafts intersecting with each other and operating in up, down, left and right directions; a controller 170 which transmits a control signal to the firearm platform 10 and controls a sighting indicator (i.e., a line) of the sighting unit 110 to be aligned with a target; and an observation unit installed in the firearm platform 10.

That is, a muzzle of the firearm 20 installed in the firearm platform 10 is position-adjusted to be pointed at the target, thereby aiming so that the sighting indicator (i.e., the line) of the sighting unit 110 can be aligned with the target.

At this time, even when the firearm 20 is detached from and attached to the firearm platform 10 for load with bullets, replacement of a gun barrel, defect in a launcher, or control, the sighting unit 110 keeps zeroed while being fastened to the firearm 20. Therefore, there is no need of zeroing in the firearm 20 again after the detachment/attachment.

Also, the sighting unit 110 for aiming the target is zeroed in the state of being assembled to the firearm 20, and is, together with the firearm 20, detached from and attached to the firearm platform 10, so that not only there will be no more concern over change in a zeroed state of the sighting unit 110 during the detachment/attachment but also the apparatus can become compact.

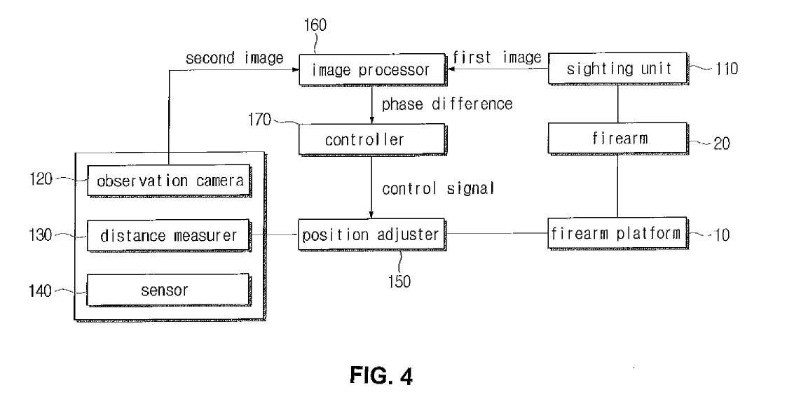

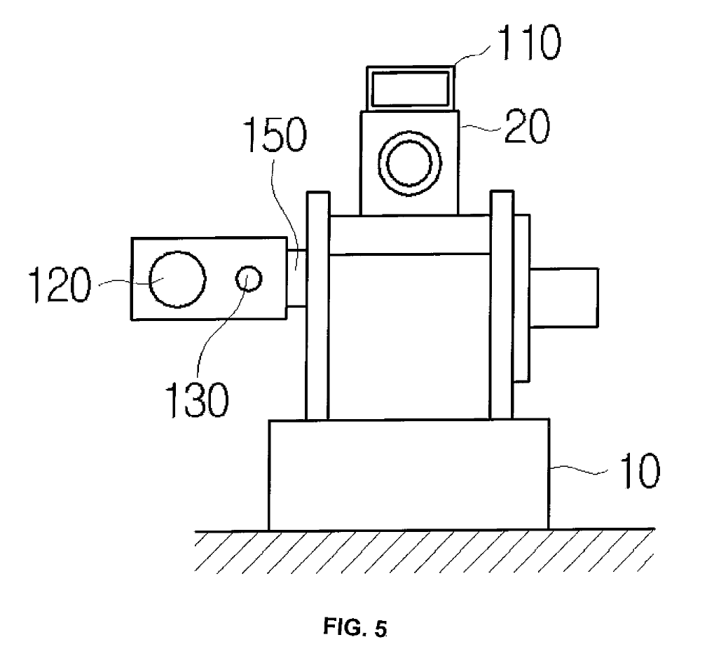

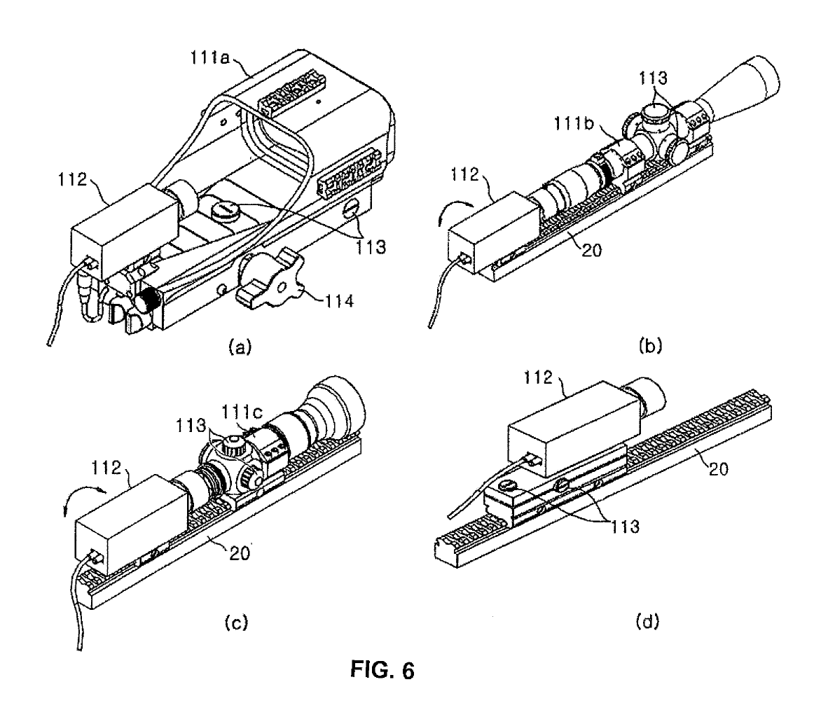

Among the accompanying drawings, FIG. 4 is a block diagram showing relationship among main elements constituting a sighting apparatus for a remote-control shooting system according to a second exemplary embodiment of the present invention, FIG. 5 is a plan view of the sighting apparatus for the remote-control shooting system according to the second exemplary embodiment of the present invention, and FIG. 6 shows various exemplary embodiments of the sighting unit 110 according to the present invention.

As shown therein, the sighting apparatus for the remote-control shooting system according to the second exemplary embodiment of the present invention includes a sighting unit 110 which is fastened to a firearm 20 as it is zeroed and takes a first image focusing on a target in the state that the firearm 20 is detachably installed in the firearm platform 10 operating in up, down, left and right directions; an observation unit which is internally provided with an observation camera 120 for taking a second image focusing on the target, a distance measurer 130 for measuring distance from the target, and a sensor 140 and installed in the firearm platform 10; a position adjuster 150 which is provided between the observation unit and the firearm platform 10 and adjusts a position of the observation unit; an image processor 160 which compares and analyzes the first image and the second image; and a controller 170 which transmits a control signal to the position adjuster 150 on the basis of an analysis result of the image processor 160 and thus adjusts the position of the observation unit.

Here, the distance measurer 130 measures distance by calculating time of a laser beam taken in being emitted to and reflected from the target, which is installed in parallel with the observation camera 120 to make a laser beam face toward the target. The sensor 140 includes a global positioning system (GPS), a digital magnetic compass (DMC), a tilt sensor for sensing an angle between the firearm platform 10 and the observation unit, etc.

Also, the position adjuster 150 includes one end fastened to the firearm platform 10 and the other end fastened to the observation unit, and adjusts the position of the observation unit on the basis of the control signal. Further, the position adjuster 150 includes one or more driving shafts.

As above, the sighting apparatus for the remote-control shooting system according to the second exemplary embodiment of the present invention controls the observation camera 120 so that the second image taken by the observation camera 120 can be aligned with the first image taken by a sighting camera 112, thereby aligning the sighting indicators (e.g., the lines) of the sighting unit 110 and the observation camera 120. In this case, it takes short time to automatically or manually align the sighting indicator (e.g. the line) in a remote place or on the spot. Further, it is possible to prevent an error in the adjustment in accordance with personal skill.

Also, the sighting unit 110 is fastened to the firearm 20 as it is zeroed, so that the position of the observation camera 120 can be adjusted by the position adjuster 150 to move the sighting indicator (e.g., the line) of the second image overlap with the sighting indicator (e.g., the line) of the first image if there is an error in the sighting indicator (e.g., the line) between the first image of the sighting unit 110 and the second image of the observation camera 120, thereby quickly and conveniently aligning the sighting indicators (e.g., the lines) of the sighting unit 110 and the observation camera 120.

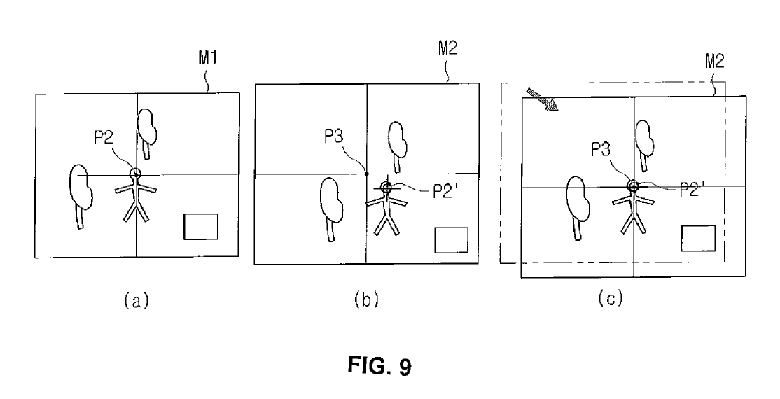

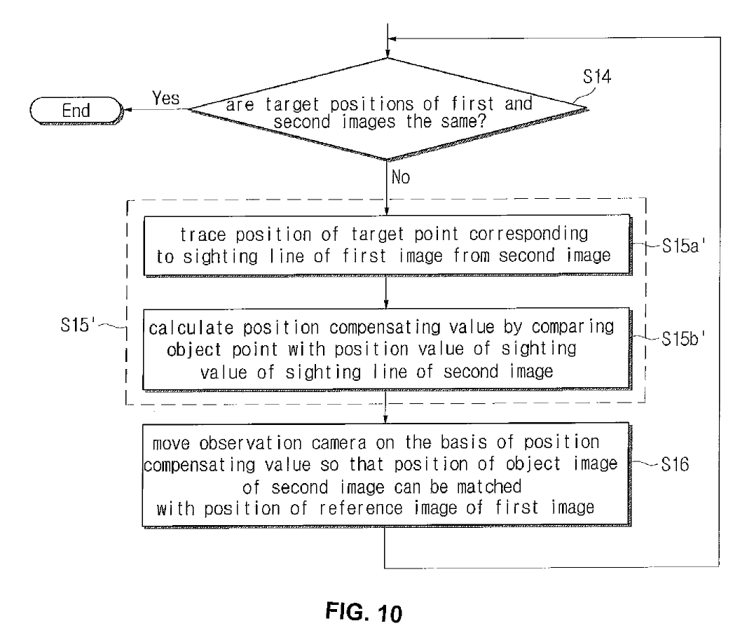

Meanwhile, the sighting unit 110 mentioned in the above exemplary embodiments may be configured in various forms as shown in FIG. 6. That is, the sighting unit 110 may include a dot sight 111a fastened to the firearm 20 through a zeroing unit 113 and a distance-based trajectory compensator 114 (refer to FIGS. 9b and 10 in Korean Patent No. 10-0906159), and a sighting camera 112 installed to have an optical axis to be aligned with the sighting indicator (e.g., the line) of the dot sight 111a as shown in (a) of FIG. 6; includes a scope 111b fastened to the firearm 20 through the zeroing unit 113, and the sighting camera 112 installed to have an optical axis to be aligned with the sighting indicator (e.g., the line) of the scope 111b as shown in (b) of FIG. 6; includes a dot sight 111c coupling with an afocal optical system fastened to the firearm 20 through the zeroing unit 113, and the sighting camera 112 installed to have an optical axis to be aligned with the sighting indicator (e.g., the line) of the dot sight 111c as shown in (c) of FIG. 6; or includes the sighting camera 112 fastened to the firearm 20 through the zeroing unit 113 and zeroed to have an optical axis to be aligned with a trajectory curve of the firearm 20 at a reference position as shown in (c) of FIG. 6.

Meanwhile, the sighting camera 112 of the sighting unit 110 may have a function of an image even in a dark night as well as a zoom function. Also, the sighting units shown in (b), (c) and (d) of FIG. 6 may also be fastened to the firearm through the distance-based trajectory compensator as shown in FIGS. 9b and 10 of Korean Patent No. 10-0906159. Such a distance-based trajectory compensator manually compensates for a trajectory in accordance with distances even though the sensor or the controller cannot be automatically controlled as it is disabled or malfunctioned under various battle environments, thereby dealing with various situations.

The image processor 160 compares the first image of the sighting unit 110 and the second image of the observation camera 120, and analyzes a position compensating value based on difference in the position between the first image and the second image. As a method of comparing the first image with the second image, there is a method of calculating the position compensating value on the basis of difference in the position between a position value of an object image corresponding to a target image and the sighting indicator (e.g., the line) of the second image by tracing the target image positioned in the sighting indicator (e.g., the line) of the first image from the second image; a method of setting up a certain image positioned around the sighting indicator (e.g., the line) as a reference image, and estimating a position compensating value by comparing a position value of the object image corresponding to the reference image in the second image with the position value of the reference image; or etc. Alternatively, the first image and the second image may be compared and analyzed with respect to the whole image.

The controller 170 sends the position adjuster 150 a control signal for adjusting the position of the observation camera 120 for taking the second image on the basis of the position compensating value calculated by the image processor 160, so that the second image can be overlapped with the first image. Also, the controller 170 sends the firearm platform 10 a control signal for adjusting the position of the firearm 20 so that the trajectory curve can intersect with the target in accordance with the distance from the target obtained by the distance measurer 130.

Below, a sighting alignment method using a sighting apparatus for a remote-control shooting system according to an exemplary embodiment of the present invention will be described.

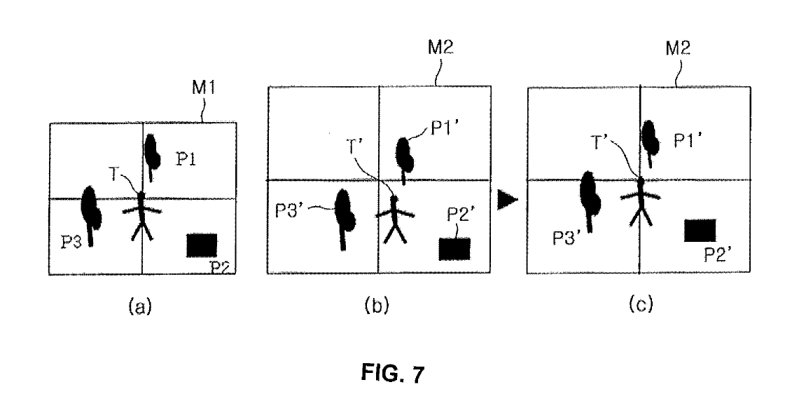

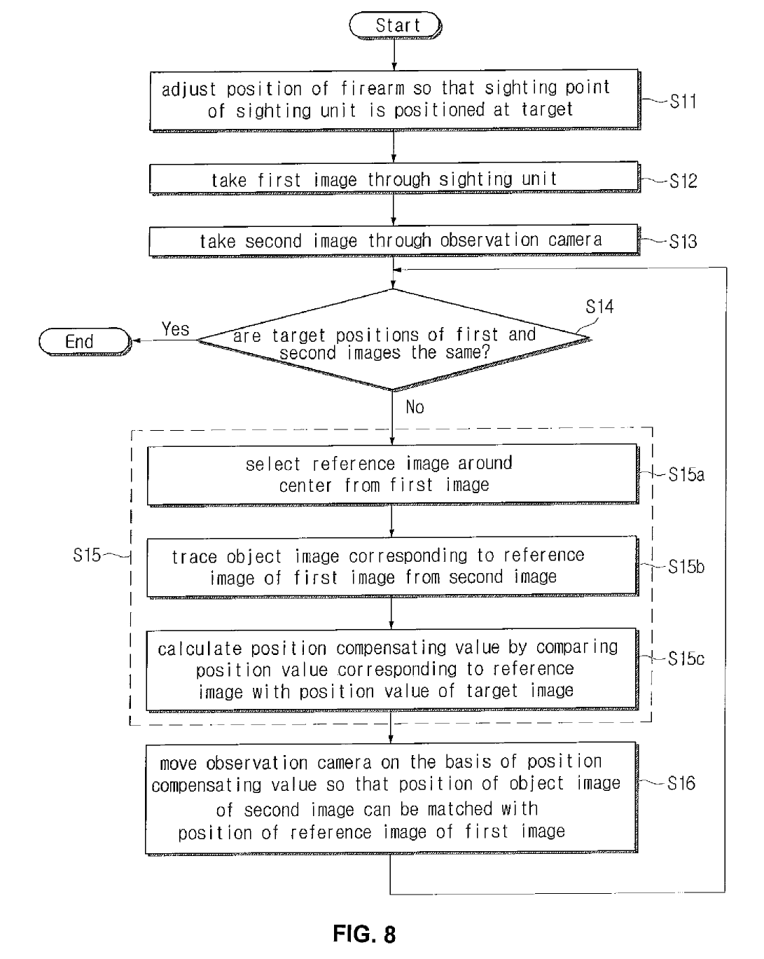

Among the accompanying drawings, FIG. 7 shows an image comparing process of a sighting alignment method using a sighting apparatus for a remote-control shooting system according to an exemplary embodiment of the present invention, and FIG. 8 is a flowchart of the sighting alignment method using the sighting apparatus for the remote-control shooting system according to an exemplary embodiment of the present invention.

As shown therein, in the state that the firearm platform 10 is driven to adjust the position of the firearm 20 so that the sighting indicator (e.g., the line) of the sighting unit 110 can be aligned with the target (S11), the first image is taken by the sighting unit 110 fastened to the firearm 20 as it is zeroed by the zeroing unit 113 (S12), and the second image is taken by the observation camera 120 fastened to the firearm platform 10 (S13).

This exemplary embodiment will be described on the assumption that the target T is positioned at the sighting indicator (e.g., the line) of the first image M1 and three reference images P1, P2 and P3 are positioned around the target T (see (a) of FIG. 7), and that the target T′ is positioned a little beyond the sighting indicator (e.g., the line) of the second image M2 and three reference images P1′, P2′ and P3′ are positioned around the target T′ (see (b) of FIG. 7).

The first image M1 taken by the sighting unit 110 is compared with the second image M2 taken by the observation camera 120, and it is determined whether the positions of the targets T and are the same (S14). If the first image M1 and the second image M2 are the same, an aligning process is completed since the sighting indicators (e.g., the lines) of the sighting unit 110 and the observation camera 120 are aligned with each other. On the other hand, if the targets T and T′ of the first image M1 and the second image M2 are different in the position from each other, the following operations (S15) are carried out.

In the case where the targets T and T′ of the first image M1 and the second image M2 are different in the position from each other, the first image M1 provided by the sighting unit 110 and the second image M2 provided by the observation camera 120 are analyzed to thereby calculate the position compensating values of the first and second images M1 and M2. Such an operation S15 for calculating a position compensating value is divided as follows.

First, the at least one of the reference images P1, P2 and P3 positioned around the sighting indicator (e.g., the line) is selected in the first image M1 of the sighting camera 112 (S15a), and then the object images P1′, P2′ and P3′ corresponding to the reference images P1, P2 and P3 are traced from the second image of the observation camera 120 (S15b). Next, distance values between the reference images P1, P2 and P3 and the object images P1′, P2′ and P3′ are respectively calculated (S15c), thereby precisely calculating the position compensating values.

Then, when the first image M1 is overlapped with the second image M1, if the observation camera 120 is moved on the basis of the position compensating values calculated as above so that the two images can be aligned with each other (S16), the object images P1′, P2′ and P3′ of the second image M2 and the reference images P1, P2 and P3 of the first image M1 are arranged on the same positions (refer to (c) of FIG. 7), and thus the sighting indicator (e.g., the line) of the sighting unit 110 and the observation camera 120 are aligned with each other.

Meanwhile, after the operation (S16) of moving the observation camera 120, the operation (S14), which determines whether the first image M1 and the second image M2 are matched with each other, returns and then the operation (S15) of calculating the position compensating value and the operation (S16) of moving the observation camera 120 are repeatedly performed until the first image M1 and the second image M2 are completely matched with each other, thereby enhancing a precision.

The sighting alignment method using the sighting apparatus for the remote-control shooting system according to the above exemplary embodiment of present invention can quickly deal with an urgent situation since the quick sighting alignment is possible without conventional separate shooting for the zeroing even through the sighting indicator (e.g., the line) is misaligned as the firearm 20 is detached/attached or controlled due to load with bullets, replacement of a gun barrel, defect in a launcher, etc.

Among the accompanying drawings, FIG. 9 shows an image comparing process of a sighting alignment method using a sighting apparatus for a remote-control shooting system according to another exemplary embodiment of the present invention, and FIG. 10 is a flowchart of the sighting alignment method using the sighting apparatus for the remote-control shooting system according to another exemplary embodiment of the present invention.

In the above exemplary embodiments, the operation of calculating the position compensating value includes selecting a reference image from a first image, and calculates the position compensating value by tracing the object image corresponding to the reference image from the second image. However, in the sighting alignment method using the sighting apparatus for the remote-control shooting system according to another exemplary embodiment of the present invention as shown in FIGS. 9 and 10, an operation S15′ of calculating a position compensating value includes selecting an object point P3 corresponding to the sighting indicator (e.g., the line) P2 of the first image M1 of the sighting camera from the second image M2 (S15a′), and calculating the position compensating value by comparing the object point with the position value of the sighting indicator (e.g., the line) of the second image.

As described above, according to an exemplary embodiment of the present invention, there is provided a sighting apparatus for a remote-control shooting system, which keeps zeroed even when a firearm is detached from and attached to a firearm platform for load with bullets, replacement of a gun barrel, defect in a launcher, or control.

According to another exemplary embodiment of the present invention, there is provided a sighting apparatus for a remote-control shooting system, in which a sighting unit for aiming at a target is assembled in a firearm as it is zeroed, so that there will be no more concern over change in a course axis even when a firearm is detached from and attached to a firearm platform, and thus the firearm platform can become lightweight.

According to still another exemplary embodiment of the present invention, there is provided a sighting alignment method using a sighting apparatus for a remote-control shooting system, which can quickly deal with an urgent situation since a sight indicator (e.g., a line) can be aligned without conventional separate shooting for the zeroing even through the sighting indicator (e.g., the line) between a sighting unit and a camera is misaligned.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An sighting apparatus for a remote-control shooting system comprising a firearm installed in a firearm platform rotatable in up, down, left and right directions, and an observation camera installed to be position-adjustable in at the firearm platform, the sighting apparatus comprising:
a sighting unit which is fastened to the firearm with a zeroing unit precisely up, down, left and right adjustable therebetween, and takes a first image as zeroed; and
a controller which controls the firearm platform so that an sighting indicator (e.g., a line) of the first image taken by the sighting unit can be aligned with a target, and aims at the target.

2. The sighting apparatus according to claim 1, further comprising an image processor which compares a first image taken by the sighting unit with a second image taken by an observation camera, and calculates a compensating value on the basis of a position of a target shown in the sighting indicator (e.g., the line) of the first image and a position of a target shown in the second image,
wherein the controller adjusts a position of the observation camera on the basis of the compensation value of the image processor so that the target shown in the second image can be positioned at the sighting indicator (e.g., the line), and thus adjusts optical axes of the sighting unit and the observation camera to face toward one target.

3. The sighting apparatus according to claim 2, further comprising a distance measurer which is installed in parallel with the observation camera and measures distance from a target.

4. The sighting apparatus according to claim 3, wherein the controller adjusts a position of a gun barrel so that a trajectory curve can intersect with a target in accordance with distance from the target based on the distance measured by the distance measurer.

5. The sighting apparatus according to claim 1, wherein the sighting unit comprises one among a dot sight, a dot sight coupling with an afocal optical system, and a scope, and a sighting cameral installed so that the sighting indicator (e.g., the fine) of one among the dot sight, the dot sight coupling with the afocal optical system, and the scope can be aligned with an optical axis.

6. The sighting apparatus according to claim 5, wherein the sighting unit is mounted to the firearm through a distance-based trajectory compensator.

7. The sighting apparatus according to claim 1, wherein the sighting unit comprises a sighting camera.

8. A sighting alignment method using the sighting apparatus for the remote-control shooting system according to claim 1, the sighting alignment method comprising:
adjusting the position of the firearm so that the sighting indicator (e.g., the line) of the sighting unit is aligned with a target (S11);
taking a first image from the sighting unit fastened to the firearm as zeroed (S12);
taking a second image from the observation camera (S13);
determining whether target positions of the first image and the second image are the same (S14);
calculating a position compensating value for the first image and the second image by analyzing the first image and the second image provided to the image processor if the target positions of the first image and the second image are different (S15); and
moving the observation camera on the basis of the position compensating value so that the first image and the second image are matched with each other (S16).

9. The sighting alignment method according to claim 8, wherein the calculating the position compensating value (S15) comprises selecting at least one reference image from the first image of the sighting camera (S15a), tracing an object image matched with a certain image of the first image from the second image of the observation camera (S15b), and calculating the position compensating value by comparing a position value corresponding to the reference image with a position value of the object image (S15c).

10. The sighting alignment method according to claim 8, wherein the calculating the position compensating value comprises selecting an object point corresponding to the sighting indicator (e.g., the line) of the first image of the sighting camera from the second image, and calculating the position compensating value by comparing the object point with the position value of the sighting indicator (e.g., the line) of the second image.

11. The sighting alignment method according to claim 9, wherein after the moving the observation camera (S16), the determining whether the first image and the second image are matched with each other (S14) returns and then the calculating the position compensating value (S15) and the moving the observation camera (S16) are repeatedly performed until the first image and the second image are matched with each other.

12. The sighting alignment method according to claim 10, wherein after the moving the observation camera (S16), the determining whether the first image and the second image are matched with each other (S14) returns and then the calculating the position compensating value (S15) and the moving the observation camera (S16) are repeatedly performed until the first image and the second image are matched with each other.

13. A sighting alignment method using the sighting apparatus for the remote-control shooting system according to claim 2, the sighting alignment method comprising:
adjusting the position of the firearm so that the sighting indicator (e.g., the line) of the sighting unit is aligned with a target (S11);
taking a first image from the sighting unit fastened to the firearm as zeroed (S12);
taking a second image from the observation camera (S13);
determining whether target positions of the first image and the second image are the same (S14);
calculating a position compensating value for the first image and the second image by analyzing the first image and the second image provided to the image processor if the target positions of the first image and the second image are different (S15); and
moving the observation camera on the basis of the position compensating value so that the first image and the second image are matched with each other (S16).

14. The sighting alignment method according to claim 13, wherein the calculating the position compensating value (S15) comprises selecting at least one reference image from the first image of the sighting camera (S15a), tracing an object image matched with a certain image of the first image from the second image of the observation camera (S15b), and calculating the position compensating value by comparing a position value corresponding to the reference image with a position value of the object image (S15c).

15. The sighting alignment method according to claim 13, wherein the calculating the position compensating value comprises selecting an object point corresponding to the sighting indicator (e.g., the line) of the first image of the sighting camera from the second image, and calculating the position compensating value by comparing the object point with the position value of the sighting indicator (e.g., the line) of the second image.

16. The sighting alignment method according to claim 14, wherein after the moving the observation camera (S16), the determining whether the first image and the second image are matched with each other (S14) returns and then the calculating the position compensating value (S15) and the moving the observation camera (S16) are repeatedly performed until the first image and the second image are matched with each other.

17. The sighting alignment method according to claim 15, wherein after the moving the observation camera (S16), the determining whether the first image and the second image are matched with each other (S14) returns and then the calculating the position compensating value (S15) and the moving the observation camera (S16) are repeatedly performed until the first image and the second image are matched with each other.
